(19) United States
(12) Patent Application Publication
(10) Pub. No.: US 2017/0351973 A1
(43) Pub. Date: Dec. 7, 2017

(54) QUANTIFYING CREATIVITY IN AUDITORY AND VISUAL MEDIUMS

(71) Applicant: RUTGERS UNIVERSITY, Piscataway, NJ (US)

(72) Inventors: AHMED ELGAMMAL, EAST WINDSOR, NJ (US); BABAK SALEH, Hoboken, NJ (US)

(73) Assignee: RUTGERS UNIVERSITY, Piscataway, NJ (US)

(21) Appl. No.: 15/612,771

(22) Filed: Jun. 2, 2017

Related U.S. Application Data
(60) Provisional application No. 62/344,715, filed on Jun. 2, 2016.

(51) Int. Cl. G06N 99/00; G06N 5/02

(52) U.S. Cl. CPC G06N 99/005; G06N 5/022

(57) ABSTRACT

This present disclosure describes a novel computational method for assessing fee creativity of human-generated and machine-generated creative products, such as paintings, sculptures, poetry, music, etc. The proposed computational method and algorithm is based on constructing a network between creative products and using this network to infer the originality arid influence of its nodes.

### CLAIM OF PRIORITY

This application is a non-provisional application and claims priority to U.S. Provisional Patent Application No. 62/344,715 filed Jun. 2, 2016, incorporated herein in its entirety.

### FIELD OF THE EMBODIMENTS

The field of the embodiments of the present invention include a method for assessing the creativity of human-generated and machine-generated creative products embodied in auditory and/or visual mediums, such as paintings, sculptures, poetry, music, etc. In particular, the present invention utilizes the most common definition of creativity, which emphasizes the originality of the product and its influential value to arrive at a creativity value or score.

### BACKGROUND OF THE EMBODIMENTS

Since the emergence of the field of artificial intelligence (AI). researchers have made significant effort to develop algorithms for generating “human-like” creative products by the machine, such as computer-generated poetry, stories, jokes, music, art, and the like. The field of computational creativity recently has focused on giving the machine the ability to generate such human-level “creative” products, as well as creative problem solving.

An important and desired characteristic of a creative agent is its ability to assess its creativity as well as judge other agents' creativity. Humans have always been the judge of creativity lending itself to the question, “is it possible that the machine be a judge for the creativity of human arid computer-generated products?” One may question the feasibility, limitation, and usefulness of performing such task by a machine. However, the present invention and its embodiments pertain to these issues, and proposes an algorithm to address this problem and show the ability of the machine to assess the creativity of human and computer generated products.

U.S. Patent Application 2014/0156379 pertains to performance data for online advertisement creatives. A hierarchical model of the online advertisement creatives may be generated based on correlations among the online advertisement creatives. The hierarchical model may be used to estimate a respective performance value for each of at least some of the plurality of online advertisement creatives based on the received performance data. A creative quality score may be determined, for those online advertising creatives whose performance values were estimated, based on the estimated performance values.

U.S. Patent Application 2015/0332313 pertains to an online system or third party system that allows advertisers to evaluate and test ad creatives before the ad creatives are presented to users in an ad campaign. Based on a set of test ad creatives for which feature scores and objective scores are determined by content evaluators (e.g., users, content processing algorithms), a model is trained to determine objective scores for an ad creative based on feature scores of the ad creative. The trained model is applied to a target ad creative, which has yet to be or has been presented to users, to determine one or more objective scores for the target ad creative based on feature scores of the target ad creative. Feedback is presented to an advertiser associated with the target ad creative based on the objective scores determined for the target ad creative.

Various devices and methodologies are known in the art. However, their structure and means of operation are substantially different from the present disclosure. At least one embodiment of this invention is presented in the drawings below and will be described in more detail herein.

### SUMMARY OF THE EMBODIMENTS

According to an aspect of the present invention, a non-transitory computer readable memory is provided that is configured to store one or more programs for execution by a processor, wherein the one or more programs has machine readable instructions that when executed by the processor cause a series of steps to be performed. The steps include inputting a first data set, via the processor, the first data set comprising a plurality of works fixed in a tangible medium and calculating, via the processor, a creativity score for each of the plurality of works, wherein calculations are performed in accordance with a creativity algorithm, and wherein the creativity algorithm comprises an originality component and an influence component. The steps further include creating a second data set, via the processor, comprising the creativity score applied to each of the components of the first data set.

According to another aspect of the present invention, a method for assessing creativity of one or more artistic works is provided. The method includes inputting a first data set, via a processor, the first data set comprising a plurality of works fixed in a tangible medium and calculating, via the processor, a creativity score for each of the plurality of works, wherein calculations are performed in accordance with a creativity algorithm, and wherein the creativity algorithm comprises an originality component and an influence component. The method further includes creating a second data set, via the processor, comprising the creativity score applied to each of the components of the first data set.

It is an object to provide the non-transitory computer readable memory, wherein the first data set comprises a plurality of paintings.

It is an object to provide the non-transitory computer readable memory, wherein the first data set includes content associated with each of the plurality of paintings, and wherein the content is selected from the group consisting of space, texture, form, shape, color, tone, and line.

It is an object to provide the non-transitory computer readable memory, wherein the first data set comprises a plurality of music recordings.

It is an object to provide the non-transitory computer readable memory, wherein the first data set includes content associated with each of the plurality of music recordings, and wherein the content is selected from the group consisting of tones, rhythm, melody, dynamic, harmony form, and texture.

It is an object to provide the non-transitory computer readable memory, wherein the machine readable Instructions, when executed by the processor, farther cause additional steps to be performed, including displaying, using a graphical user interface, one or more creativity scores in the second data set.

It is an object to provide the non-transitory computer readable memory, wherein the displaying further includes organizing the one or more creativity scores in the second data set as a graphical representation.

It is an object to provide the non-transitory computer readable memory, wherein the graphical representation organizes the one or more creativity scores in the second data set according to date of production of the work and according to creativity score.

It is an object to provide the method for assessing creativity of one or more artistic works, further comprising assigning one or more parameters, wherein each parameter includes a different means of assigning the creativity score to each of the components of the first data set.

It is an object to provide the method for assessing creativity of one or more artistic works, wherein the parameters are input by a user using a graphical user interface.

It is an object to provide the method for assessing creativity of one or more artistic works, further comprising digitizing one or more of the plurality of works using a camera coupled to an electronic device.

It is an object to provide the method for assessing creativity of one or more artistic works, wherein the electronic device is a mobile electronic device.

It is an object to provide the method for assessing creativity of one or more artistic works, wherein the first data set comprises a plurality of paintings.

It is an object to provide the method for assessing creativity of one or more artistic works, wherein the first data set includes content associated with each of the plurality of paintings, and wherein the content is selected from the group consisting of space, texture, form, shape, color, tone, and line.

It is an object to provide the method for assessing creativity of one or more artistic works, wherein the first data set comprises a plurality of music recordings.

It is an object to provide the method for assessing creativity of one or more artistic works, wherein the first data set includes content associated with each of the plurality of music recordings, and wherein the content is selected from the group consisting of tones, rhythm, melody, dynamic, harmony form, and texture.

It is an object to provide the method for assessing creativity of one or more artistic works, further comprising displaying, using a graphical user interlace, one or more creativity scores in the second data set.

It is an object to provide the method for assessing creativity of one or more artistic works, wherein the displaying further includes organizing the one or more creativity scores in the second data set as a graphical representation.

It is an object to provide the method for assessing creativity of one or more artistic works, wherein the graphical representation organizes the one or more creativity scores In the second data set according to date of production of the work and according to creativity score.

### BRIEF DESCRIPTION OF THE DRAWINGS

FIG. 1 shows a graphical representation of creativity scores obtained on a dataset containing a number of paintings, according to an embodiment of the present invention.

FIG. 2 shows an illustration of the construction of a Creativity Implication Network, according to an embodiment of the present invention.

FIG. 3 shows an example of a graph produced from a two-dimensional analysis of creativity, according to an embodiment of the present invention.

FIG. 4 shows a flowchart showing a method for assessing creativity of one or more artistic works, according to an embodiment of the present invention,

FIG. 5 shows a system for assessing creativity of one or more artistic works, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can lie made thereto.

According to an embodiment, a computational method for assessing the creativity of products, such as paintings, sculptures, music, etc. is provided. These products need not only be the result of human activity. These products can also be the creation of machines. According to an embodiment, the most common definition of creativity is used, which emphasizes the originality of the product and its influential value.

According to an embodiment, the proposed computational framework is based on constructing a network between products and using it to infer about the originality and influence of its nodes. Through a series of transformations, the problem can be reduced to a variant of network centrality problems, which can be solved efficiently. The proposed framework, is applied to the task of quantifying creativity of paintings, sculptures, music, etc.

The input for a creativity-assessment algorithm is an encoding of the content in the product. This encoding varies depending on the content. In music, for example, this can be any digitized encoding of the musical elements, such as tones, rhythm, melody, dynamic, harmony form, texture, etc. In the domain of visual art, artists, an historians, and critics use different concepts to describe visual artistic works. In particular, elements of visual artistic works such as, but not limited to, space, texture, form, shape, color, tone, and line are used to describe visual artistic works. Artists also use principles of art including, but not limited to, movement, unity, harmony, variety, balance, contrast, proportion, and pattern, besides brush strokes, subject matter, and other descriptive concepts. These concepts are collectively referred to as artistic concepts.

These artistic concepts can, more or less, be quantified by today's computer vision technology. With the rapid progress in computer vision, more advanced techniques are introduced, which can be used to measure similarities between paintings with respect to a given artistic concept. According to an embodiment, a framework is provided that can use such similarity measures to quantify a chosen definition of creativity in an objective way. Hence, the proposed framework provides a ready-to-use approach that can utilize any future advances in computer vision that might provide better ways for visual quantification of one or more works of art such as, but not limited to, digitized paintings. For example, the proposed framework has been validated by applying state-of-the-art computer vision techniques and achieved very reasonable automatic quantifications of creativity on two large datasets of paintings. The quantification of creativity obtained by the algorithm is consistent with what art historians typically cite as most creative and transformative works of art at their time.

Typically visual, auditory, and/or other contents are digitized from their original analog forms to a digital binary format of ones and zeros to be processed by the computer. The digitization devices for visual content may include, but are not limited to, digital cameras, analog cameras connected to analog to digital converter, document scanners, cell phone cameras, web cameras, etc. Images arid video of visual contents available on the web are already digitized. The digitization devices for the auditory contents can be microphone connected to analog to digital converters to generate a digital audio stream of the analog audio.

The input to the algorithm can also be a native digital content that is generated directly using a computer in digital format. This includes Graphic designs, drawings, paintings, CAD drawings, etc., generated or manipulated by any digital authoring tools (e.g. Photoshop, etc.). This also includes generated music using digital music authoring tools.

According to an embodiment, the digitized visual medium is saved compressed or uncompressed using various file formats including, but not limited to, JPG, JPG2000, PNG, BMP, PDF, TIFF, GIF, MPEG, AVI, etc. The digitized auditory medium is typically saved in compressed or uncompressed formats including, but not limited to. MP3, MPEG, WAV, MEDI, etc.

The input to the algorithm can lie a file of any of these formats or any future or otherwise suitable digital formats. The input to the algorithm can also be directly captured by a camera or a digitization device and passed to the algorithm directly without being saved to a file.

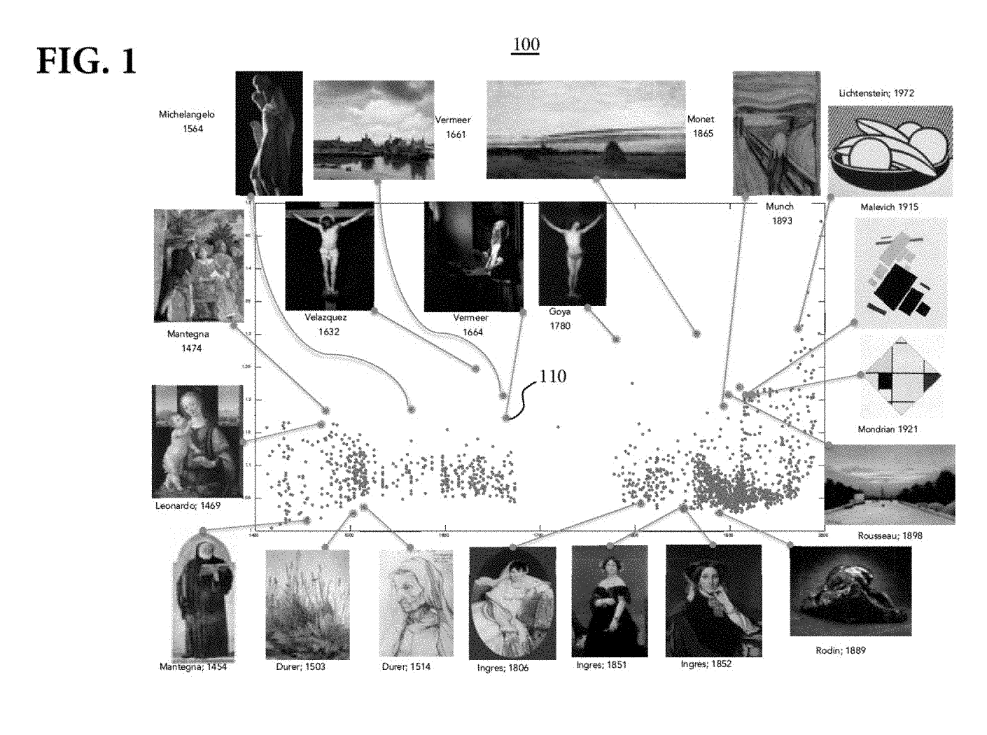

Referring now to FIG. 1, a graphical representation of creativity scores 110 obtained on a dataset containing 1,710 paintings is illustratively depicted, in accordance with an embodiment of the present invention.

According to an embodiment, each point 110 on the graph 100 represents a painting. The horizontal axis is the year the painting was created and the vertical axis is the creativity score (scaled). The thumbnails illustrate some of the paintings that scored relatively high or low compared to their neighbors. Only artist names and dates of the paintings are shown.

One of the fundamental issues with the problem of quantifying creativity of art is how to validate any results that the algorithm can obtain. Even if art historians would agree on a list of highly original and influential paintings that can be used for validation, any algorithm that aims at assigning creativity scores will encounter three major types of limitations:

I) Closed-world limitations: The algorithm is only limited to the set of paintings (or other works of art) that are analyzed. It is a closed world for the algorithm where this set pertains to all art in art history that the algorithm has analyzed. The number of images of paintings available in the public domain is just a small fraction of what are in museums and private collections.

II) Artistic concept quantification limitations: The algorithm is limited by what it sees, in terms of the ability of the underlying computer vision methods to encode the Important elements and principles of art that relate to judging creativity.

III) Parameter setting limitations: The results will depend on the settings of the parameters, wherein each setting refers to a different means of assigning creativity scores with different interpretations and different criteria.

As more and more artistic works are digitized, as well as with the continuing advances in computer vision and machine learning, the first two limitations are bound to eventually be miniscule. The third limitation should be thought of as an advantage, since the different settings mean a rich ability of the algorithm to assign creativity scores based on different criteria. For the purpose of validation, a methodology for validating the results of the algorithm is proposed through what is denoted as “time machine experiments”, which provide evidence of the correctness of the algorithm.

From a computational creativity point of view, evaluating the framework on digitized art data provides an excellent way to optimize and validate the framework, since art history provides us with suggestions about what is considered creative and what might be less creative. Validating the framework on digitized art data makes it possible to be used on other products where no such knowledge is available. For example, the framework may be used to validate any number of computer-generated creative products.

There is a historically long and ongoing debate on how to define creativity. A person (e.g. artist, poet, etc.), a product (e.g., painting, poem, etc.), and/or a mental, process can be described as being creative. Among the various definitions of creativity, it seems that there is a convergence to two main conditions for a product to be called “creative”. The product must be novel, compared to prior work, and also has to be of value or influential Associating creativity with products makes it possible to argue in favor of “Computational Creativity”, since otherwise, any computer product would be an output of an algorithmic process and not a result of a creative process. Hence, the present invention quantifies the creativity of products instead of the mental processes that are used to create the product.

There is a proposed distinction between two notions of creativity: psychological creativity (P-creativity). which assesses novelty of ideas with respect to its creator; and historical creativity (H-creativity), which assesses novelty with respect to the whole human history. It follows that. P-creativity is a necessary but not sufficient condition for H-creativity, while H-creativity implies P-creativity. This distinction is related to the subjective creativity (related to person) vs. objective creativity (related to the product). According to an embodiment, the definition of creativity used is aligned with objective/H-creativity, quantifying creativity within an historical context. It is noted, however, that other definitions of creativity may also be used in conjunction with the present invention.

A creative product must be original, compared to prior work, and valuable (influential), moving forward. According to an embodiment, a network of creative products is constructed and used to assign a creativity score to each product in the network according to the aforementioned criteria. According to an embodiment, this approach is used in reference to a network of paintings. It is noted, however, that the framework is applicable to other art or literature forms.

According to an embodiment, a set of paintings is denoted by P={pᵢ, i . . . N}. The goal is to assign a creativity score for each painting, denoted by C(pᵢ) for painting pᵢ. Every painting comes with a time label indicating the date it was created, denoted by t(pᵢ). According to an embodiment, a directed graph is created wherein each vertex corresponds to a painting. A directed edge (arc) connects painting pᵢ to pⱼ if pᵢ was created before pⱼ. Each directed edge is assigned a positive weight, wherein the weight of edge (pᵢ, pⱼ) is denoted by wᵢⱼ.

According to an embodiment, Wᵢⱼ is denoted as the adjacency matrix of the painting graph, where Wᵢⱼ=wᵢⱼ, if there is an edge from pᵢ to pⱼ, and 0 otherwise. Note that, according to this definition, a painting is not connected to itself, i.e., wᵢⱼ=0, i=1 . . . N. By construction, Wᵢⱼ>0→wᵢⱼ=0, i.e., the graph is anti-symmetric.

To assign the weights, it is assumed that there is a similarity function that takes two paintings and produces a positive scalar measure of affinity between them (higher value indicates higher similarity). Such a function is denoted by S( . , . ) and, therefore,

$${w}_{ij} = \{ \begin{matrix}S ( {p}_{i} , {p}_{j} ) & if t ( {p}_{i} ) < t ( {p}_{j} ) \\ 0 & otherwise\end{matrix}$$

Since there are multiple possible visual aspects that can be used to measure similarity, such a function is denoted by S^{a}( . , . ), where the superscript a indicates the visual aspect (artistic concept) that is used to measure the similarity (e.g., color, subject matter, brush stroke, etc.). This implies that multiple graphs can be constructed, one for each similarity function.

According to an embodiment, the corresponding adjacency matrix is denoted by W^{a}, and the induced creativity score is denoted by C^{a}, which measures the creativity along the dimension of visual aspect a. According to an embodiment, the different adjacency matrices can also be combined by weighting the different concepts to achieve one adjacency matrix, capturing these concepts collectively. According to an embodiment, these weights can be imposed based on prior knowledge and/or can be learned from data.

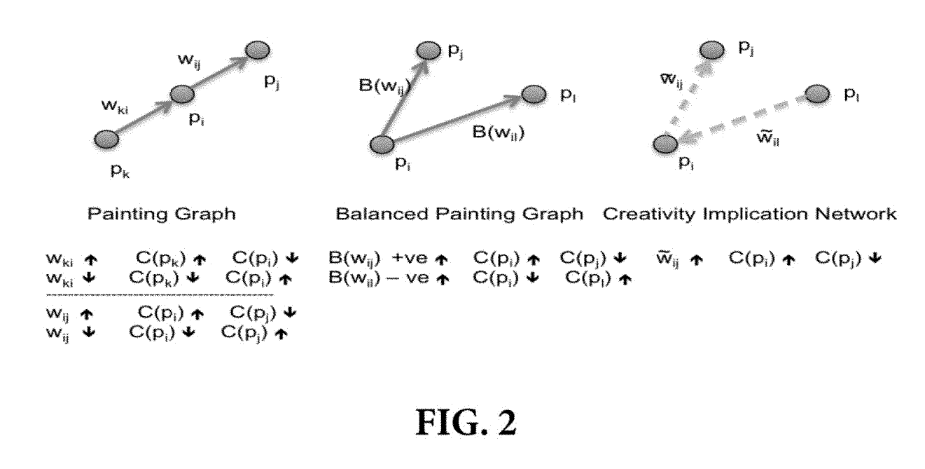

Referring now to FIG. 2, an illustration of the construction of a Creativity Implication Network is illustratively depicted, in accordance with an embodiment of the present invention.

Giving the constructed painting graph, how can the creativity be propagated in such a network? To answer this question, it is necessary to understand the implication of the weight of the directed edge connecting two nodes on their creativity scores. According to an embodiment, it is assumed that equal creativity indices are assigned to all nodes. For example, consider painting pᵢ and consider an incoming edge from a prior painting pₖ. A high weight on that edge (wₖᵢ) indicates a high similarity between pᵢ and pₖ, which indicates that pᵢ is not novel, implying that the creativity score of pᵢ should be decreased (since pᵢ is subsequent to pₖ and similar to it) and the creativity score of pk should be increased. In contrast, a low weight implies that pᵢ is novel and hence creative, compared to pₖ. Therefore, in this example, the creativity score of pᵢ should be increased and the creativity score of pₖ should be decreased.

The outgoing edges from pᵢ are now considered. According to the present notion of creativity, for pᵢ to be creative, it is not enough to be novel, it has to be influential as well (e.g., some others have to imitate it). This indicates that a high weight, wᵢⱼ, between pᵢ and a subsequent painting pⱼ implies that the creativity score of pᵢ should he increased and the creativity score of pⱼ should be decreased. In contrast, a lower weight implies that pᵢ is not influential on pⱼ, and, hence, the creativity score for pᵢ should be decreased and the creativity score for pⱼ should be increased. These tour cases are illustrated in FIG. 2, wherein the solid arrows indicate temporal relation and the dashed arrows indicate reverse creativity implication. A careful look reveals that the two cases for the incoming edges and those for the outgoing edges are in fact the same. According to an embodiment, a higher weight implies that the prior node is more influential and the subsequent node is less creative, and a lower weight implies the prior node is less influential and the subsequent node is more creative.

Before converting tills intuition to a computational approach, it needs to be defined what is considered high and low for weights. A balancing function Is thus introduced on the graph. Let m(i) denote a balancing value for node i, wherein, for the edges connected to that node, a weight above m(i) is considered high and, below that value, is considered low. The balancing function is defined as a linear function on the weights connecting each node in the form:

$${B}_{i} ( w ) = \{ \begin{matrix}w - m ( i ) & if w > 0 \\ 0 & otherwise\end{matrix}$$

According to an embodiment, there may be different forms of balancing functions that can be used. Also there may be different ways to set the parameter m(i) with different implications. This form of balancing function basically converts weights lower than m(i) to negative values. The more negative the weight of an edge, the more creative the subsequent node, and the less influential the prior node. The more positive the weight of an edge, the less creative the subsequent node, and the more influential the prior node.

The introduction of the negative weights in the graph, despite providing a solution to represent low weights, is problematic when propagating the creativity scores. The intuition is, a negative edge between pᵢ and pⱼ is equivalent to a positive edge between pⱼ and pᵢ. This directly suggests that all negative edges should be reversed and their values negated. Notice that the original graph construction guarantees that an edge between pᵢ and pⱼ implies no edge between pⱼ and pᵢ. Therefore, there is no problem with edge reversal. This process results in what can be called the “Creativity Implication Network”. The weights of that graph are denoted by \tilde{w}ᵢⱼ and its adjacency matrix by \tilde{W}. This process can be described mathematically as:

B(wᵢⱼ)>0→\tilde{w}ᵢⱼ=B(wᵢⱼ)

B(wᵢⱼ)=0→\tilde{w}ᵢⱼ=0

B(wᵢⱼ)<0→\tilde{w}ⱼᵢ=−B(wᵢⱼ)

The Creativity Implication Network has one simple rule that relates its weights to creativity propagation: the higher the weight of an edge between two nodes, the less creative the subsequent node and the more creative the prior node. Note that the direction of the edges in this graph is no longer related to the temporal relation between its nodes. Instead, it is directly inverse to the way creativity scores should propagate from one painting to another. Also notice that the weights of this graph are non-negative.

Given the construction of the Creativity Implication Network, a recursive formula for assigning creativity scores can now be defined. The construction of the Creativity Implication Network reduces the problem of computing the creativity scores to a traditional network centrality problem. The algorithm maintains creativity scores that sum up to one, i.e., the creativity scores form a probability distribution over all of the paintings in a set of paintings. Given an initial equal creativity scores, the creativity score of node pᵢ should be updated as:

$$C ( {p}_{i} ) = \frac{( 1 - α )}{N} + α {\sum }_{j} {\tilde{w}}_{ij} \frac{C ( {p}_{j} )}{N ( {p}_{j} )}$$

herein referred to as Eq. 1, where 0≦a≦1 and N(pⱼ)=Σₖ\tilde{w}ₖⱼ. In this formula, the creativity of node pᵢ is computed from aggregating a fraction of the creativity scores from its outgoing edges, weighted by the adjusted weights wᵢⱼ. The constant term (1-α)/N reflects the chance that a similarity between two paintings might not necessarily indicate that the subsequent one is influenced by the prior one. For example, two paintings might be similar simply because they follow a certain style or art movement. The factor 1-α reflects the probability of this chance. The normalization term N(pⱼ) for node j is the sum of its incoming weights, which means that the contribution of node pⱼ is split among all its incoming nodes based on the weights, and, hence, pᵢ will collect only a fraction, \tilde{w}ᵢⱼ/Σₖ\tilde{w}ₖⱼ, of the creativity score of pⱼ.

The recursive formula in Eq. 1 can be written in a matrix for, as:

$$C = \frac{( 1 - α )}{N} 1 + α \tilde{\tilde{W}} C ,$$

herein referred to as Eq. 2, where \tilde{\tilde{W}} is a column stochastic matrix defined as \tilde{\tilde{W}}ᵢⱼ=\tilde{w}ᵢⱼ/Σₖ\tilde{w}ₖⱼ, and 1 is a vector of ones of the same size as C. It is easy to see that since \tilde{\tilde{W}}, C, and

$$\frac{1}{N} 1$$

are all column stochastic, the resulting scores will always sum up to one. The creativity scores can be obtained by iterating over Eq. 2 until conversion. Also a closed-form solution for the case where α≠1 can be obtained as

$${C}^{*} = \frac{( 1 - α )}{N} {( I - α \tilde{\tilde{W}} )}^{- 1} 1 ,$$

herein referred to as Eq. 3.

The formulation above sums up the two criteria of creativity, being original and being influential. According to an embodiment, the formulation may be modified to make it possible to give more emphasis to either of these two aspects when computing the creativity scores. For example, it might be desirable to emphasize novel works, even though they are not influential, or vice versa.

Recall that the direction of the edges in the Creativity Implication Network are no longer related to the temporal relation between the nodes. The edges in the network can he labeled such that each outgoing edge, e(pᵢ, pⱼ), from a given node pᵢ is either labeled as a subsequent edge or a prior edge, depending on the temporal relation between pᵢ and pⱼ. This can be achieved by defining two disjoint subsets of the edges in the networks:

E^{prior}={e(pᵢ,pⱼ):t(pⱼ)<t(pᵢ)}

E^{subseq}={e(pᵢ, pⱼ):t(pⱼ)≧t(pᵢ)}.

This results in two adjacent matrices, denoted by \tilde{W}^{p} and \tilde{W}^{s}, such that \tilde{W}=\tilde{W}^{p}+\tilde{W}^{s}, where the superscripts p and s denote the prior and subsequent edges, respectively. Now, Eq. 1 can be written as:

$$C ( {p}_{i} ) = \frac{( 1 + α )}{N} + α [ β {\sum }_{j} {\tilde{w}}_{ij}^{p} \frac{C ( {p}_{j} )}{{N}^{p} ( {p}_{j} )} + ( 1 - β ) {\sum }_{j} {\tilde{w}}_{ij}^{s} \frac{C ( {p}_{j} )}{{N}^{s} ( {p}_{j} )} ] ,$$

herein referred to as Eq. 4, and where N^{p}(pⱼ)=Σₖ\tilde{w}ₖⱼ^{p} and N^{s}(pⱼ)=Σₖ\tilde{w}ₖⱼ^{s}. The first summation collects the creativity scores stemming from prior nodes, i.e., encodes the originality part of the score, while the second summation collects creativity scores stemming from subsequent nodes, i.e, encodes influence. Parameter 0≦β≦1 was introduced to control the effect of the two criteria on the result. The modified formulation above can be written as:

$$C = \frac{( 1 - α )}{N} 1 + α [ β {\tilde{\tilde{W}}}^{p} C + ( 1 - β ) {\tilde{\tilde{W}}}^{s} C ] ,$$

herein referred to as Eq. 5, and where \tilde{\tilde{W}}^{p} and \tilde{\tilde{W}}^{s} are the column stochastic adjacency matrices resulting from normalizing the columns of \tilde{W}^{p} and \tilde{W}^{s}, respectively. The closed-form solution in Eq. 3 is applicable to this modified formulation, where \tilde{\tilde{W}} is defined as:

\tilde{\tilde{W}}=β\tilde{\tilde{W}}^{p}+(1−β)W^{s}.

The input to the algorithm features encoded content in the visual or auditory input. Typically, digital media is analyzed to extract descriptive features that encode certain information and aspects in the media that are required to be processed. For visual art, the encoding can reflect any of, or any combination of, elements and principles of art (e.g., line, texture, color, form, subject matter, brush strokes, composition, motifs, patterns, etc.). For music or other auditory art, the encoding can be any digitized encoding of the musical elements, such as, e.g., tones, rhythm, melody, dynamic, harmony form, texture, etc.

This can be achieved by using various signal processing, image processing, computer vision, and machine learning tools to encode the content. This includes, but is not limited to, Fourier transform. Wavelet transform, edge detection, image segmentation, image gradient, texture descriptor, boundary detection, shape descriptors, color and intensity histograms, etc. According to an embodiment, this also includes the use of machine learning techniques to learn encoding from data directly optimized on certain supervised or unsupervised tasks (e.g., using metric learning, support vector machining, dimensionality reduction, vector quantization etc.). This also includes features obtained through training deep neural networks to learn representations from data directly. Such representations can also be used as encoding for the input content.

The algorithm can take, as input, one or several of these features and encode to generate a creativity assessment. The different input encodings can be integrated to generate one creativity assessment of the input or can be processed in parallel to generate multiple creativity assessments, one for each input encoding, to generate a multi-dimensional creativity assessment. For example, for a given painting, the algorithm can generate an assessment of the creativity for its composition, subject matter, light, texture, etc.

According to an embodiment, the algorithm can use any content encoding method to generate creativity scores with respect to such encoding.

According to an embodiment, the algorithm is orthogonal to the choice of the digitization and/or the choice of the content encoding technique.

Such features are denoted by fᵢ^{a} for product pᵢ, where a denotes the visual or auditory aspect that the feature quantifies.

Regarding visual likelihood, similarity between product pᵢ and pⱼ is defined as the likelihood that product pⱼ is coming from a probability model defined by painting pᵢ. This probability likelihood can be computed by a variety of statistical models. This includes, e.g., assuming a probability distribution, whether in a parametric (e.g., Gaussian distribution, Exponential distribution, etc.) or in non-parametric way (e.g., using histograms, kernel density estimation methods, etc.). The likelihood can also be the outcome of a neural network or a regression model (e.g., a logistic regression, etc.). The similarity can also be defined based on any appropriate function of the distance in the feature space between the products. The distance can be computed based on any mathematical norm (e.g. Euclidean norm, L1 norm, L0 norm, fractional norms, etc.). The distance can also be learned using machine learning metric learning techniques.

In particular, according to an embodiment, a Gaussian probability model for painting pt can lie assumed, i.e.:

S^{a}(pⱼ, pᵢ)=Pr(pⱼ|pᵢ, a)= [symbol] ( [symbol] fᵢ^{a}, σ^{a}I).

According to an embodiment, it is important to limit the connections coming to a given painting. By construction, any painting will be connected to all prior paintings in the graph. This mates the graph highly biased since modern paintings will have extensive incoming connections and early paintings will have extensive outgoing connections. Therefore, the incoming connections are limited to any node to at most the top K edges (the K most similar prior paintings). K is a parameter of the method and can vary from 1 to the number of products in the collection.

According to an embodiment, it may be desirable to add a temporal prior on the connections. If a painting in the nineteenth century resembles a painting from the fourteenth century, the painting should not necessarily he penalized as low creativity. This is because certain styles are always reinventions of older styles (e.g., neoclassicism and renaissance). Therefore, these similarities between styles across distant time periods should not be considered as low creativity. Therefore, a temporal prior can be added if needed. One way to add such a temporal prior is as a second multiplicative term, as:

S^{a}(pⱼ, pᵢ)=Pr^{v}(pⱼ|pᵢ, a)·Pr^{t}(pⱼ|pᵢ),
where the second probability is a temporal likelihood (the likelihood that pⱼ is influenced by pᵢ, given their dates) and the first is the visual likelihood. There are different ways to define such a temporal likelihood. The simplest way is a temporal window function, i.e., Pr^{t}(pⱼ|pᵢ)=1, if pᵢ is within K temporal neighbors prior to pⱼ and 0 otherwise. Alternatively, a Gaussian density can be used, Pr^{t}(pⱼ|pᵢ)=exp(−|t(pᵢ)−t(pⱼ)|²/σₜ².

There are different choices for the balancing function as well as the parameter for that function. According to an embodiment, a linear function is used. It is noted, however, that non-linear functions may also be used, while maintaining the spirit of the present invention. The parameter m can be set globally over the whole graph, or locally for each time period. A global m can be set as the p-percentile of the weights of the graph, which is p-percentile of all the pairwise likelihoods. This directly means that p % of the edges of the graph will be reversed when constructing the Creativity Implication Graph. One disadvantage of a global balancing function is that different time periods have different distributions of weights. This suggests using a local-in-time balancing function. To achieve this, m is computed for each node as p % of the weight distribution based on its temporal neighborhood.

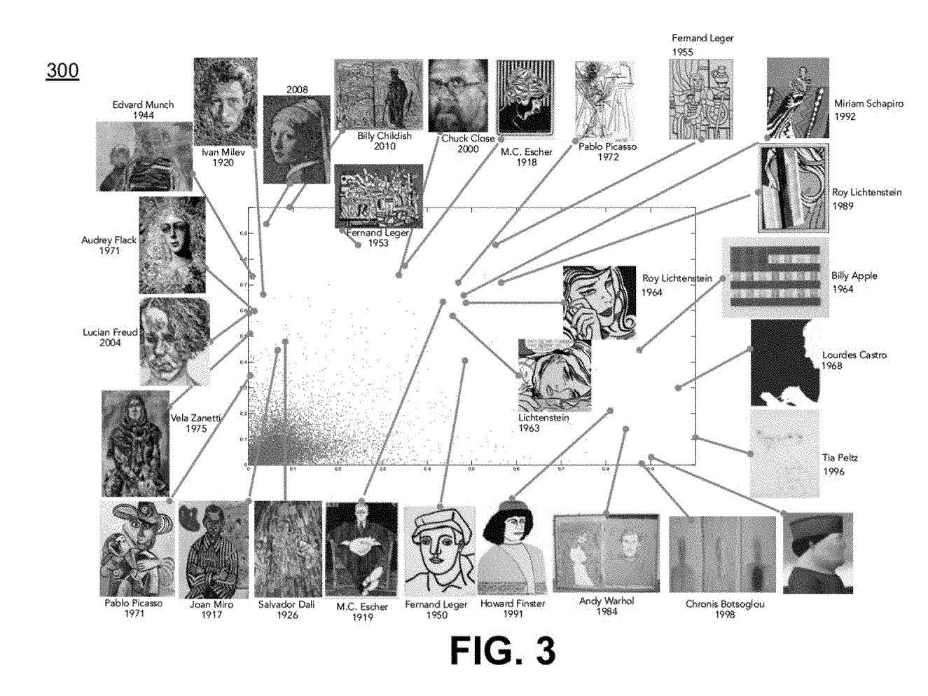

Referring no w to FIG. 3, an example of a graph 300 produced from a two-dimensional analysis of creativity is illustratively depicted, in accordance with an embodiment of the present invention.

According to the embodiment shown in FIG. 3, a subset of portrait paintings from a Wikiart dataset was used, which contains 12,310 paintings from the period AD 1420-2011. Creativity of each of these paintings was analyzed using the algorithm, which is orthogonal to the choice of feature encoding. According to an embodiment, the algorithm incorporates features that provide semantic-level representations of images, by encoding the presence of a set of basic-level object categories (e.g. horse, cross, etc,), which captures the subject matter of the paintings. Some of the low-level features used to learn these features also capture the composition of the scene. According to an embodiment, the algorithm incorporates features that mainly encode scene decomposition along several perceptual dimensions (e.g., naturalness, openness, roughness, expansion, ruggedness, etc.). These features are widely used in computer vision literature for scene classification.

According to an embodiment, the features incorporated by the algorithm yield two dimensions of creativity coordinates. Each point in the plot represents a single painting with two creativity scores. Unlike FIG. 1, which shows creativity vs. time, FIG. 3 shows absolute creativity with respect to the two dimensions (i.e., the relative creativity cannot be judged at any point of time from this plot). This makes the plot biased towards visualizing modern paintings. It is clear from the plot that the horizontal axis correlates with abstraction in the shape and form, while the vertical axis correlates with texture and pattern.

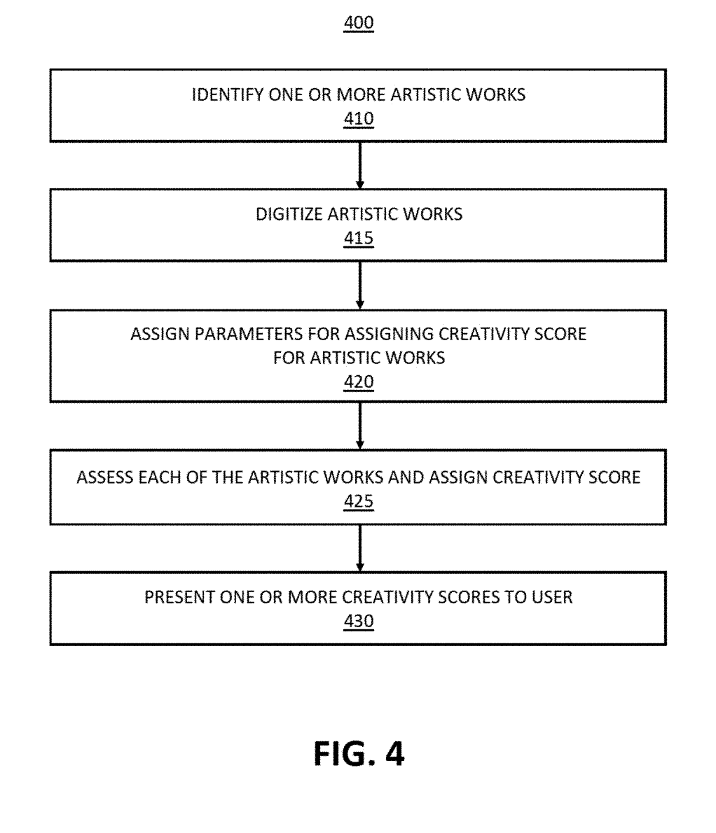

Referring now to FIG. 4, a flowchart showing a method 400 for assessing creativity of one or more artistic works is illustratively depicted, in accordance with an embodiment of the present invention.

At step 410, artistic works are identified. These works can be visual works, auditory works, and/or other forms of artistic media.

At step 415, once identified, the artistic works are digitized. According to an embodiment, the digitization includes separating the artistic works by artistic medium such as, but not limited to, visual works, auditory works, paintings, sculptures, etc.

Once digitized, each of the digitized artistic works, at step 320, are encoded, incorporating elements of the artistic piece and principles of the artistic piece. The elements may include, for paintings, style, subject-matter, background, place of origin, type of paint used, etc. The elements may include, for auditory artistic works, tones, rhythm, melody, dynamic, harmony form, texture, etc.

At step 420, one or more parameters for assigning a creativity score to each of the artistic works are selected. The parameters may include different means of assigning creativity scores with different interpretations and different criteria. According to an embodiment, the parameters are chosen by a user using a graphical user interface coupled to an electronic device.

At step 425, using the parameters, fee algorithm assesses each of the artistic works and assigns a creativity score to one or more of the artistic works. According to an embodiment, the assessment including analyzing each of the artistic works against a database of analyzed artistic works. According to an embodiment, the creativity score is assigned to each artistic work. According to an embodiment, a creativity score is assigned to one or more artists whose work or works were analyzed.

Quantifying creativity as an attribute of a product facilitates quantifying the creativity of the person who made that product, as a function over the creator's set of products. Hence, the present framework also serves as a way to quantify creativity as an attribute for individuals as well as artistic works.

At step 430, one or more creativity scores are presented to the user using the graphical user interlace. According to an embodiment, the presentation takes the form of a constructed graph of two or more creativity scores.

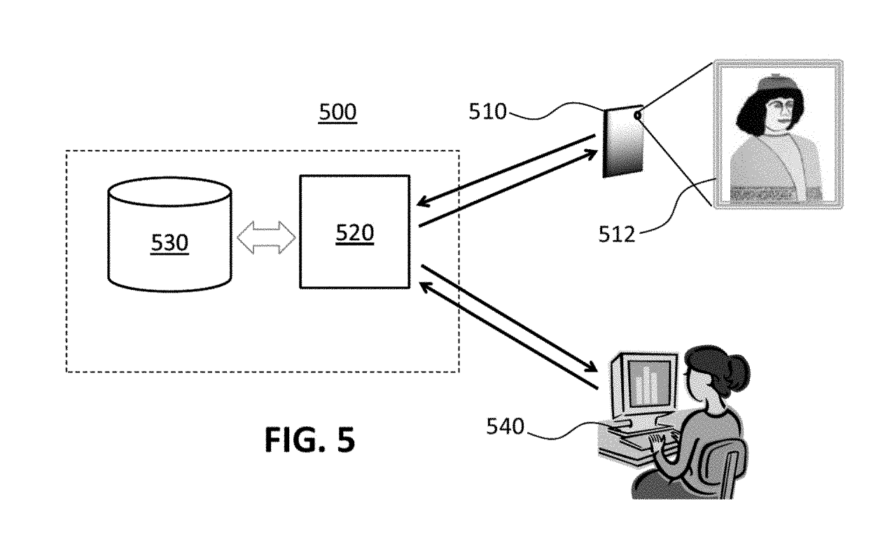

Referring now to FIG. 5, a system 500 for assessing creativity of one or more artistic works is illustratively depicted, in accordance with an embodiment of the present invention.

According to an embodiment, the system 500 includes an electronic device 510 including a camera, a cloud-based server 520, a storage system 530 including a memory, and a secondary electronic device 540.

According to an embodiment, electronic device 510 is configured to take photographs of one or more visual artistic works 512 and send the digitized images to the cloud-based server 520. The secondary electronic device 540 may also send digitized images and/or other digitized artistic works to the cloud-based server 520.

According to an embodiment, the cloud-based server 520 stores one or more digitized artistic works in the storage system 530. The storage system 530 may include a memory a processor and may store an algorithm for assessing the creativity of one or more artistic works.

According to an embodiment, once the one or more artistic works are assessed for creativity, each of the one or more artistic works are assigned a creativity score. One or more creativity scores are presented to the user using a graphical user interface coupled to the electronic device 510, 540. According to an embodiment, the presentation takes the form of a constructed graph of two or more creativity scores.

### Systems, Devices and Operating Systems

Typically, a user or users, which may lie people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations.

One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval analysis, and manipulation, which may be facilitated through a database program. These information technology systems provide interfaces that allow users to access and operate various system components.

In one embodiment, the present invention may he connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computers), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like. The connections may he wired and/or wireless and/or may include cloud computing technology.

Networks are commonly thought to comprise the interconnection, and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients,” The term “client” as used herein refers generally to a computer, program, other device, user and/or combination thereof that is capable of processing and making requests and obtaining and processing any responses from servers across a communications network.

A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks. Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

### Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an Interface bus, and most frequently, although not necessarily, are ail interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may he connected to the system bus.

In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like.

The system clock, typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer sysfemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors nay include internal fast access addressable memory, and be capable of mapping and addressing memory beyond the processor itself; internal memory may include, but is not limited to: fast registers, various levels of cache memory (e.g., level 1, 2, 3, etc.), RAM, etc.

The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processors). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), Graphical Processing Units (“GPUs”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention.

A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

### Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source Is connected to the system bus component. In an alternative embodiment, an outside power source is provided through a connection across the I/O interface. For example, a USB and/or IEEE 1394 connection carries both data and power across the connection and is therefore a suitable source of power.

### Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, hot not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, find/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention.

A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, cloud computing, and/or the like); and/or the like. A network interlace may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface; Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like.

One typical output device may include a video display, which typically comprises a Cathode Ray Tube (CRT) or Liquid Crystal Display (LCD) based monitor with an interface (e.g., DVI circuitry and cable) that accepts signals from a video interlace, may be used. The video interface composites information generated by a computer systemization and generates video signals based on the composited information in a video memory frame. Another output device is a television set, which accepts signals from a video interface. Typically, the video interlace provides the composited video Information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the system may be connected and/or communicate to I/O and/or other facilities of the like such as network interlaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC6HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz RoadRunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may he configured wherein the functionality of on-chip CPU memory (e.g., registers), RAM, ROM, and any other storage devices are provided by a paper punch tape or paper punch card mechanism; of course such an embodiment would result in an extremely slow rate of operation.

In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, MD DVD R/RW etc,); an array of devices (e.g., Redundant Array of independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory may contain a collection of program and/or database components and/or data such as, but not limited to: operating system component(s) (operating system); information server component(s) (information server); user interface components) (user interface); Web browser component(s) (Web browser); database(s); mail server components); mail client component(s); cryptographic server component(s) (cryptographic server) and/or the like (i.e., collectively a component collection). These components may be stored and accessed from the storage devices and/or from storage, devices accessible through an interface bus. Although non-conventional program components such as those in the component collection, typically, are stored in a local storage device, they may also be loaded and/or stored in memory such as: peripheral devices. RAM, remote storage facilities through a communications network, ROM, various forms of memory, and/or the like.

### Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like.

Most frequently, the operating system communicates with other program components, user interlaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

### Information Server

An information server component is a stored program component that is executed by a CPU. The information server may be a conventional Internet information server such as, but not limited to Apache Software Foundation's Apache, Microsoft's Internet Information Server, and/or the like. The information server nay allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The Information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo-Instant Messenger Service, and/or the like.

The information server provides results in the form of Web pages to Web browsers, and allows for the manipulated generation of the Web pages through interaction with other program components. After a Domain Name System (DNS) resolution portion of an HTTP request is resolved to a particular information server, the Information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.”

Additionally, other information serving protocols may he employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields.

In one embodiment, the parser may generate queries in standard SQL by instantiating a search string with the proper join/select commands based on the fagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interlace libraries (e.g., ActiveX, AJAX, (D)HTML, FLASH, Java, JavaScript, etc, interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users nay affect, interact, and/or operate a computer system. A user interface may communicate to and/or with other components in a component collection, including Itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component is a stored program component that is executed by a CPU. The Web browser may be a conventional hypertext viewing application such as Microsoft Internet Explorer or Netscape Navigator, Secure Web browsing may be supplied with 128 bit (or greater) encryption by way of HTTPS, SSL, and/or the like, Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like, Web browsers and like information access tools may be integrated into PDAs, cellular telephones, and/or other mobile devices.

A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of coarse, in place of a Web browser and information server, a combined application may he developed to perform similar functions of both. The combined application would similarly affect the obtaining and the provision of Information to users, user agents, and/or the like from the enabled nodes of the present invention. The combined application may be nugatory on systems employing standard Web browsers.

### Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes. Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention nay be achieved through a number of APIs offered by the individual. Web server components and/or the operating system.

Also, a mail server may contain, communicate, generate, obtain, and/or provide program component, system, user, and/or data communications, requests, information, and/or responses.

### Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component is a stored program component that is executed by a CPU, cryptographic processor, cryptographic processor interlace, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum. Data Encryption Standard (DES), Elliptical Curve Encryption (ECC ), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network.

The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio tile. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it nay act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### A Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase, Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely Identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be Integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

Although this invention has been described with a certain degree of particularity, it is to be understood that the present disclosure has been made only by way of illustration and that, numerous changes in the details of construction and arrangement of parts may be resorted to without departing from the spirit and the scope of the invention.

What is claimed is:

1. A non-transitory computer readable memory configured to store one or more programs for execution by a processor, wherein the one or more programs has machine readable instructions that when executed by the processor cause the following steps to be performed:
inputting a first data set, via the processor, the first data set comprising a plurality of works fixed in a tangible medium;
calculating, via the processor, a creativity score for each of the plurality of works,
wherein calculations are performed in accordance with a creativity algorithm.
wherein the creativity algorithm comprises an originality
component and an influence component; and
creating a second data set, via the processor, comprising the creativity score applied to each of the components of the first data set.

2. The non-transitory computer readable memory as recited in claim 1, wherein the first data set comprises a plurality of paintings.

3. The non-transitory computer readable memory as recited in claim 2, wherein the first data set includes content associated with each of the plurality of paintings, and
wherein the content is selected from the group consisting of space; texture; form; shape; color; tone; and line.

4. The non-transitory computer readable memory as recited in claim 1, wherein the first data set comprises a plurality of music recordings.

5. The non-transitory computer readable memory as recited in claim 4, wherein the first data set includes content associated with each of the plurality of music recordings, and
wherein the content is selected from the group consisting of: tones; rhythm; melody; dynamic; harmony form; and texture.

6. The non-transitory computer readable memory as recited in claim 1, wherein the machine readable instructions, when executed by the processor, further cause the following steps to be performed:
displaying, using a graphical user interface, one or more creativity scores in the second data set.

7. The non-transitory computer readable memory as recited in claim 6, wherein the displaying farther includes organizing the one or more creativity scores in the second data set as a graphical representation.

8. The non-transitory computer readable memory as recited in claim 7, wherein the graphical representation organizes the one or more creativity scores in the second data set according to date of production of the work and according to creativity score.

9. A method for assessing creativity of one or more artistic works, the method comprising:
inputting a first data set, via a processor, the first data set comprising a plurality of works fixed in a tangible medium;
calculating, via the processor, a creativity score for each of the plurality of works,
wherein calculations are performed in accordance with a creativity algorithm,
wherein the creativity algorithm comprises an originality component and an influence component; and
creating a second data set, via the processor, comprising the creativity score applied to each of the components of the first data set.

10. The method as recited in claim 9, further comprising assigning one or more parameters, wherein each parameter includes a different means of assigning the creativity score to each of the components of the first data set.

11. The method as recited in claim 10, wherein the parameters are input by a user using a graphical user interface.

12. The method as recited in claim 9, further comprising digitizing one or more of the plurality of works using a camera coupled to an electronic device.

13. The method as recited in claim 9, wherein the calculating includes determined the originality component and the influence component individually

14. The method as recited in claim 9, wherein the first data set comprises a plurality of artistic works selected from the group consisting of: paintings; music recordings; photographs; graphical designs; and motion pictures.

15. The method as recited in claim 14, wherein the first data set includes content associated with each of the plurality of artistic works

16. The method as recited in claim 15, wherein the content is selected from the group consisting of: space; texture; form; shape; color; tone; line; tones; rhythm; melody; dynamic; harmony form; and texture.

17. The method as recited in claim 9, wherein the calculating the creativity score further includes calculating a creativity score for a particular artist.

18. The method as recited in claim 9, further comprising:
displaying, using a graphical user interface, one or more creativity scores in the second data set.

19. The method as recited in claim 18, wherein the displaying further includes organizing the one or more creativity scores in the second data set as a graphical representation.

20. The method as recited in claim 19, wherein the graphical representation organizes the one or more creativity scores in the second data set according to date of production of the work and according to creativity score.
